(19) United States
(12) Patent Application Publication
(10) Pub. No.: US 2015/0365681 A1
(43) Pub. Date: Dec. 17, 2015

(54) METHOD OF ENCODING AND DECODING VIDEO STREAM FOR IMAGE COMPRESSION

(71) Applicant: Chih-Ta Star Sung, HsinChu (TW)

(72) Inventor: Chih-Ta Star Sung, HsinChu (TW)

(21) Appl. No.: 14/301,336

(22) Filed: Jun. 11, 2014

(51) Int. Cl. H04N 19/182; H04N 19/127; H04N 19/176

(52) U.S. Cl. CPC H04N 19/182; H04N 19/176; H04N 19/127

(57) ABSTRACT

The present invention is related to a method of the video data encoding and decoding, which plays an important role in digital video compression and decompression, specifically in encoding and decoding the video stream. The present invention significantly reduces the computing times compared to its counterparts in the field of video compression.

### FIELD OF INVENTION

The present invention relates to a method for encoding image data and more particularly relates to a method for encoding a video stream by reference to previous encoded data.

### BACKGROUND

Video encoding is more and more complicated when resolution of video is getting larger and larger. Without an efficient algorithm for handling video encoding, it is very difficult to handle video encoding, particularly for instant recoding.

### SUMMARY OF INVENTION

The present invention is a method for encoding a video stream which includes a series of images divided into several blocks. The method saves information of reference blocks in a buffer. When encoding a current block, the method calculates the entire divergent level between the current block and one or more reference blocks to find a similar reference block. The best match block has a high similarity with the current image block and it is considered as a best match reference block. If the best match reference block exists, the method copies the corresponding encoded result of the best match reference block and differences as the encoded result of the current image block differences. But if the best match reference block does not exist, the current image block is converted into frequency space and ignoring part of image elements to acquire the encoded result of the current block.

### BRIEF DESCRIPTION OF THE DRAWING

FIG. 1 depicts the block and pixel differences encoding mechanism, the entire divergent level is used to determine whether or not the previously encoded block can be used by the current block and current pixel.

FIG. 2 shows the layers of the MPEG bit stream which includes from top to down: the sequence layer, group of picture (GOP) layer, picture layer, slice layer, macro block layer and block layer.

FIG. 3 is an illustration of the best match block searching from a previous image and a next image. The concept of the searching range is also depicted in this figure.

FIG. 4A illustrates the efficient P-frame and B-frame video compression procedure and method, which results in video encoding according to the present invention.

FIG. 4B summarizes the SAD range that decides which kind of compressions is needed for encoding.

FIG. 5 depicts an example of the block differences comparison mechanism of the neighboring blocks which more quickly determines which previously compressed blocks can be used by the current block.

FIG. 6 depicts an example of the pixel differences comparison mechanism of the neighboring pixels which more quickly determines which previously compressed pixels can be used by the current pixel.

FIG. 7 depicts the concept of subsampling of pixel selection and block selection. The selection procedure is demonstrated in this figure by 2:1 and 4:1 subsampling ratios.

FIG. 8 depicts the buffer where stores five different targets according to the present invention.

### DETAILED DESCRIPTION

The present invention relates specifically to the video bit stream encoding. The method quickly encodes the current data, which results in a significant saving of the computing time.

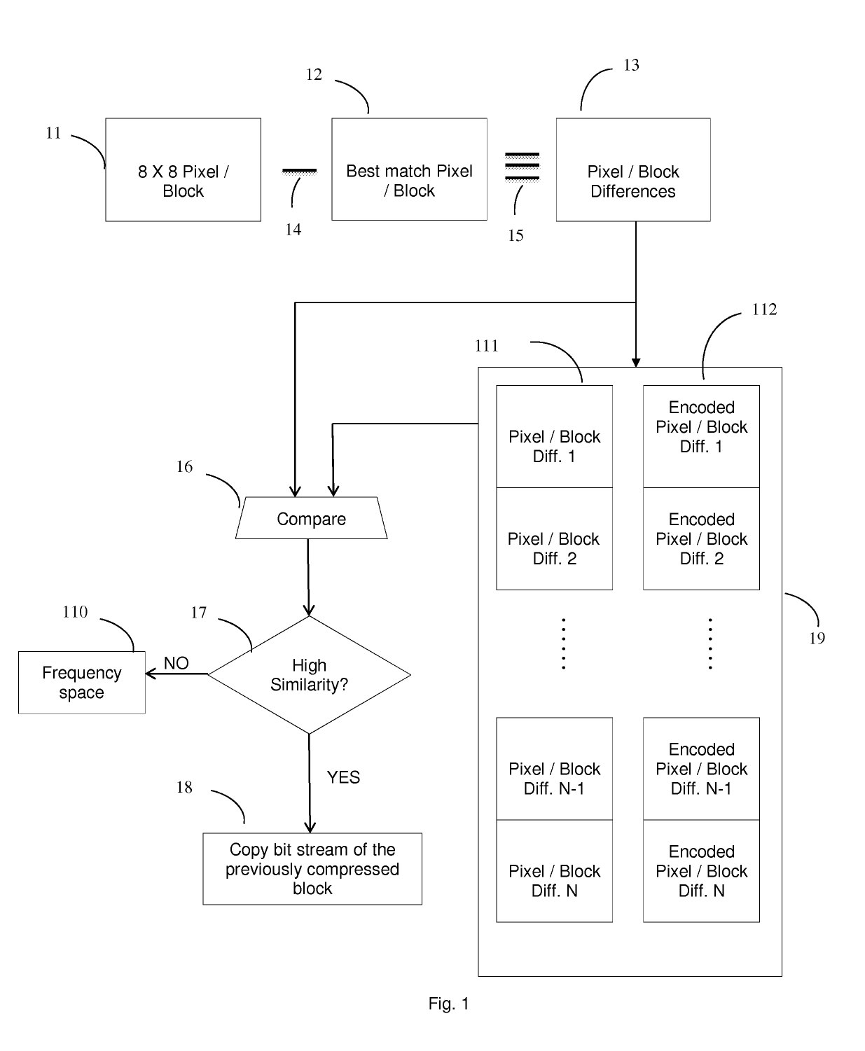

FIG. 1 shows a comparison procedure of pixel differences and block differences 13. The key point is that there is a buffer 19 saving information of reference block differences and reference pixel differences 111. When encoding a current data 11, calculating the entire divergent level to choose which compression procedures should be used. If the current data is not smaller than the predetermined thresholds, the method chooses the further compression procedure to find the best match pixel or block 12 from the buffer 19 and compare 16 them. If the best match reference pixel or block 17 exists, copying the corresponding encoded results of the best match reference pixel or block as the encoded result of the current data 18. If the best match reference pixel or block 17 does not exist, then exchanging the current blocks 11 into frequency space 110 and ignoring a part of image elements and doing further compression procedure to acquire the encoded result of the current data 11.

The compressed pixels and blocks 112 within an image are stored into a buffer 19 and the reference block differences and reference pixel differences 111 are compared to the current pixel and current block 11 to determine which of the reference block differences and reference pixel differences 111 is the most similar one which can be used to represent the current pixel or current block 11. If the pixel differences or block differences 13 is beyond the predetermined threshold and no equal block is identified, then pixel differences or block differences 13 is compared to other predetermined threshold which is decided to check which compression procedure is going to be used.

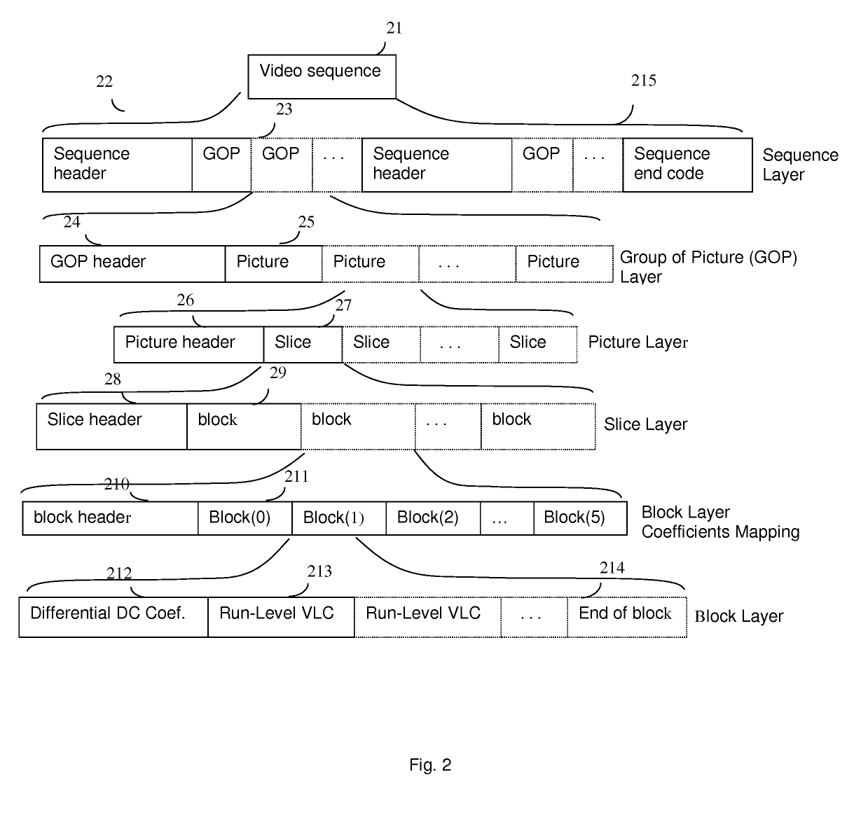

FIG. 2 shows in principle, the three types of picture encoding in the MPEG video compression standard including I-frame, the “Intra-coded” picture, P-frame, the “Predictive” picture and B-frame, the “Bi-directional” interpolated picture.

I-frame encoding uses the 8×8 block of pixels within an image to code information of itself. The P-frame block encoding uses previous I-frame or P-frame as a reference to code the difference. The B-frame-block encoding uses previous I-or P-frame as well as the next I-or P-frame as references to code the pixel information. In most applications, since the I-frame does not use any other image as reference and hence no need of the motion estimation, the image quality is the best of the three types of pictures, and requires least computing power in encoding. Because of the motion estimation needs to be done in both previous and next images, bi-directional encoding, encoding the B-frame has lowest bit rate, but consumes most computing power compared to I-frame and P-frame. The lower bit rate of B-frame compared to P-frame and I-frame is contributed by the factors including: the averaging block displacement of a B-frame to either previous or next image is less than that of the P-frame and the quantization step is larger than that in a P-frame. Therefore, the encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

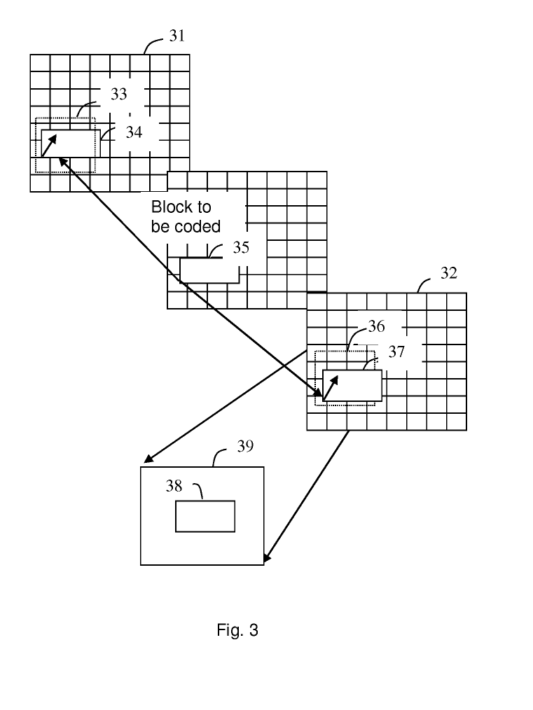

FIG. 3 shows the best match block searching from some previous images 31 and the next few images 32. If the method successfully finds the best match block 37 from one of the previous 31 and next few blocks 32, they can be represented as the encoded results 38 of the current blocks 35.

A motion estimator searches for the best match block within a predetermined searching range 33, 36, 39 by comparing the mean absolute difference, MAD, or sum of absolute differences, SAD. The block of certain of position having the least MAD or SAD is identified as the best match block 38. Once the best match block 38 is identified, the motion vector, MV, between the current block 35 and the best match blocks 34, 37 can be calculated and the differences between each block within a block can be coded accordingly, this kind of block differences encoding technique is called Motion Compensation.

Motion compensation is an algorithmic technique employed in the encoding of video data for video compression, for example in the generation of MPEG-2 files. Motion compensation describes a picture in terms of the transformation of a reference image to the current image. The reference image may be previous in time or even from the future. When images can be accurately synthesized from previously transmitted or stored images, the compression efficiency can be improved. Using motion compensation, a video stream will contain some reference images; then the only information stored for the images in between would be the information needed to transform the previous image into the next image.

The Motion Vector, MV, represents the direction and displacement of the movement of blocks and pixels. For example, an MV=(5,-3) stands for the block movement of 5 pixels right in X-axis and 3 pixel down in the Y-axis. For minimizing the time of searching, the motion estimator searches for the best match block only within a predetermined searching range.

As previously mentioned, the video compression procedure takes block as the compression unit, the present invention minimizes the number of blocks that need to go through the complete video compression procedure, thereof significantly reduces the time of computing in video compression. In the present invention, the pixels are examined from time to time and partitioned to be “background-like”, “object-like” and others regions for the reference in future images.

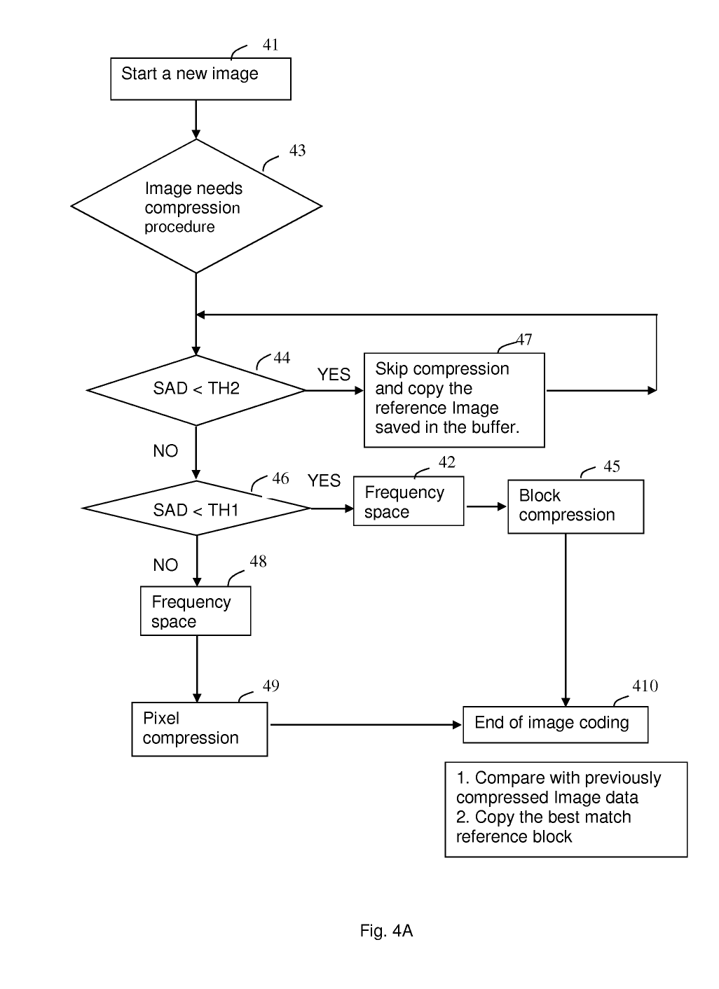

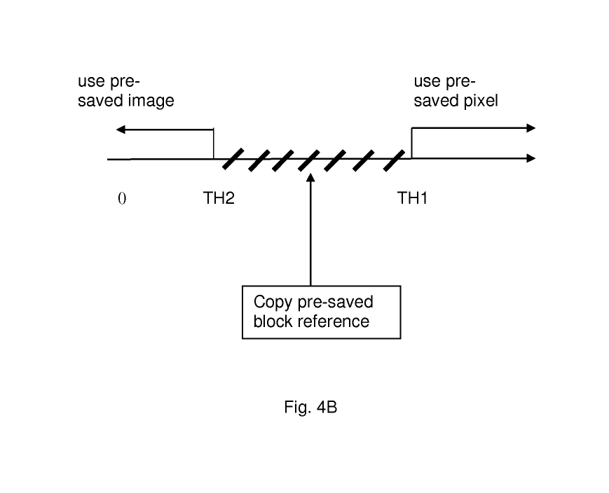

FIG. 4A shows the video compression procedure and method of the present invention. A current image 41 is compared with previous image saved in the buffer with predetermined threshold values to decide whether this image need to go through the video compression procedure or not. If the current image 41 has high similarity with the previous image, then it does not need to go through another compressions 45, 49. That is to say, the SAD is smaller than TH2 44. In the present invention, a skip compression 47 operation will be applied by copying the reference images in the buffer to represent the present image. According to the present invention, the skip compression operation 47 becomes practical, the reference images are temporarily saved in a storage device, which can be copied to represent the current image.

If the current image 41 needs to be compressed through the further procedures, the first step is to find the best match block by calculating the SAD, sum absolute difference. Second, when the SAD falls within TH1 and TH2, said TH2<SAD<TH1, the block need to change to frequency space 42 and go through the block compression procedure 45. The block within the background region or within the inner region of an object, said 2-3 block away from the edge of an object block, is very likely needs block compression procedure 45 only. Otherwise, the pixel compression procedure 49 is needed. It needs to remove some part of information when going through the frequency space 42 as long as they are not lossless to represent the original current image. When the block with highest similarity is identified, the reference blocks are copied to represent the present block.

If SAD of the current image is not smaller than TH1 44, go through frequency space 48 to ignore some other information to conduct the pixel compression 49. For this function to be practically feasible, the SAD of pixels is used in the present invention to identify the concept of said “Similarity”.

The Best Match Algorithm, BMA, is most commonly used motion estimation algorithm in the popular video compression standards like MPEG and H.26×. In most video compression systems, motion estimation consumes high computing power ranging from ˜50% of the total computing power of the video compression. In the search for the best match macro-block, a searching range, for example +/−16 pixels in both X-and Y-axis, is most commonly defined. The mean absolute difference, MAD or sum of absolute difference, SAD as shown below, is calculated for each position of a macro-block within the predetermined searching range, for example, a +/−16

$$S A D ( x , y ) = {\sum }_{i = 0}^{15} {\sum }_{j = 0}^{15} \vert {V}_{n} ( x + i , y + j ) - {V}_{m} ( x + dx + i , y + dy + j ) \vert$$

$$M A D ( x , y ) = \frac{1}{256} {\sum }_{i = 0}^{15} {\sum }_{j = 0}^{15} \vert {V}_{n} ( x + i , y + j ) - {V}_{m} ( x + dx + i , y + dy + j ) \vert$$

pixel of the X-axis and Y-axis. In digital image processing, the sum of absolute differences (SAD) is an algorithm for measuring the similarity between blocks. It works by taking the absolute difference between each pixel in the original block and the corresponding pixel in the block being used for comparison. The sum of absolute differences may be used for a variety of purposes, such as object recognition, the generation of disparity maps for stereo images, and motion estimation for video compression. The block with the least MAD (or SAD) is from the BMA definition named the best match block.

FIG. 4B shows the determination of whether to go to which compression procedure. When SAD is not smaller than TH1, this current data goes through the pixel compression steps by converted to frequency space and ignore some part of information; when smaller than TH2, the current data is assigned to avoid compression steps to copy the reference images saved in the buffer to represent the current one. If SAD is between TH1 and TH2, the block differences comparison mechanism is applied to identify which previous compressed block can be used to represent the current block.

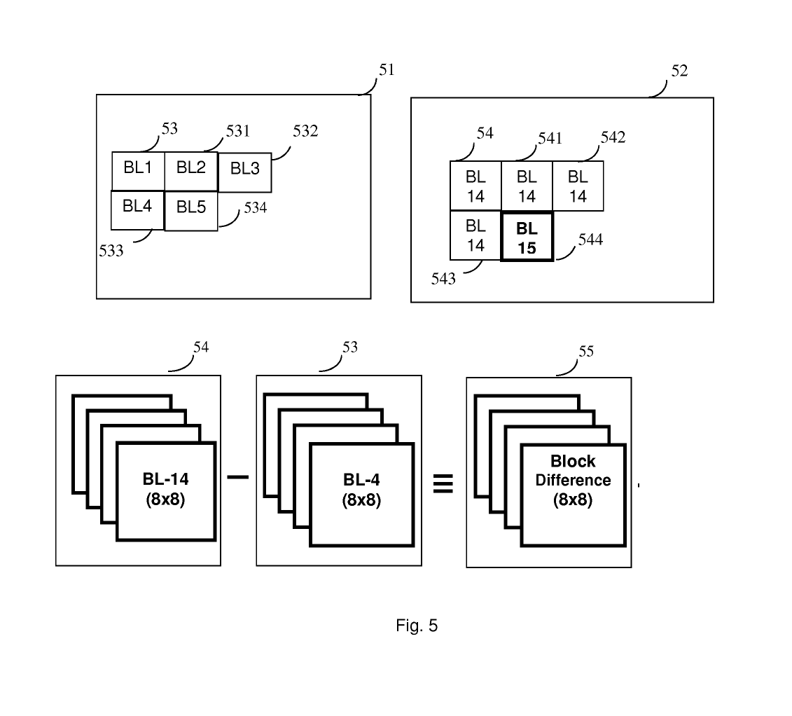

FIG. 5 shows some blocks, which are examples illustrating the concept of block correlation and a procedure of identifying the block similarity. Due to the factor that the block correlation will be higher in neighboring blocks, the block differences 55 comparison starting from neighboring blocks can much quickly find the block having high similarity. The block compression procedure by the means of comparing the block correlation among blocks can be expanded to compare all blocks within an image 51 which significantly reduces the computing time by avoiding the complete compression operations.

A target block 544 within the current image 52 is surrounded by an upper row of blocks 54, 541, 542 and the left block 543. Blocks 53 within one of reference are the corresponding best match block. The block pixel differences 55 are the differences between the blocks 54 of the present image 52 and their corresponding best match blocks 53 in one of references. Block differences 55 and the corresponding compressed reference block are saved temporarily in a buffer.

If the block differences 55 are beyond the predetermined threshold value and no equal block is identified, then the block differences are compared to another predetermined threshold value which is decided by the quantization to check whether the variance range of the block differences are small enough to ignore some part of the image.

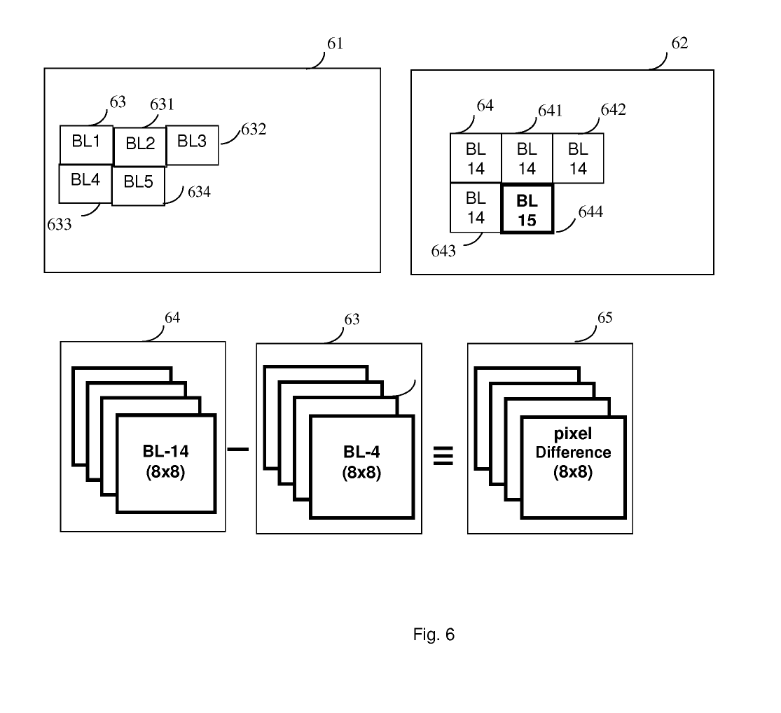

FIG. 6 shows, generally 60, some pixels, which is are examples illustrating the concept of pixel correlation and a procedure of identifying the pixel similarity. Due to the factor that the pixel correlation will be higher in neighboring pixels, the pixel differences comparison starting from neighboring pixels can much quickly find the pixel having high similarity. The pixel compression procedure by the means of comparing the pixel correlation among pixels can be expanded to compare all pixels within a block which significantly reduces the computing time by avoiding the complete compression operations.

The pixel differences between the target pixel 644 and the best match pixel 634 is compared to the pixel differences 65 of its surrounding pixels, to decide which pixel differences is the most similar one. If the differences are smaller than a predetermined threshold value, then its compressed bit stream is copied to represent the current block. The compressed pixels within a block are saved into a buffer and their uncompressed pixels are compared to the target block pixel 644 to determine which of the previously compressed pixels is the most similar one and can be used to represent the current pixel 644.

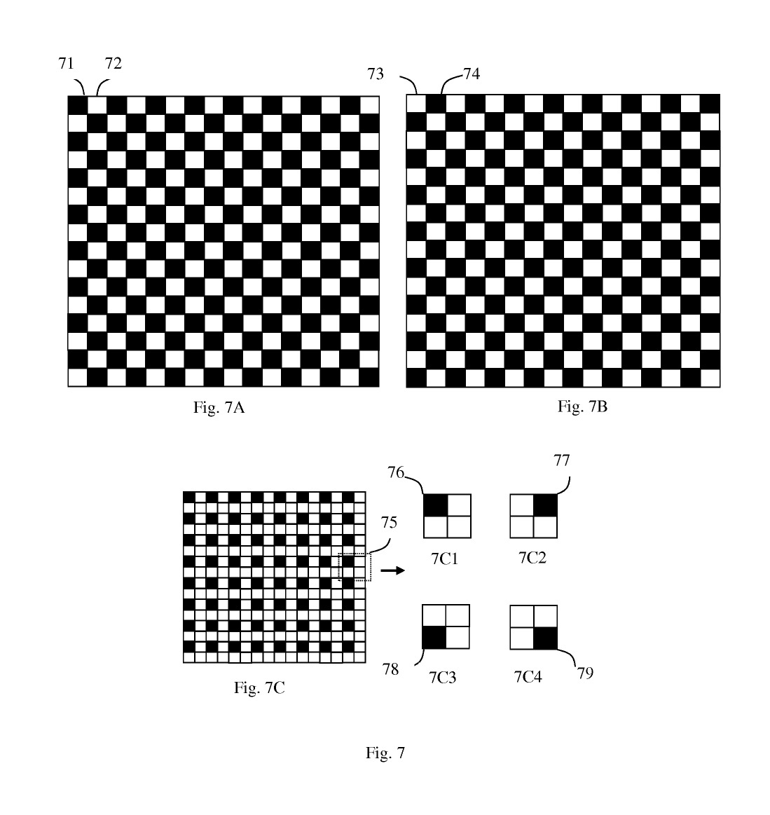

FIG. 7 illustrates the means of the pixel subsampling and examples of 2:1 and 4:1 subsampling ratios. Since subsampling does not include all pixels in the motion estimation, some degree of potential error is expected. For minimizing the error caused by subsampling, the present invention uses an optimized subsampling means by periodically rotating the selection pixel of each image.

FIG. 7A shows the 2:1 sampling ratio, in this example, the black position 71 represents the selected pixel, and the blank position 72 represents the unselected pixel. In the next image, as shown in FIG. 7B, the selected pixel of previous image FIG. 7A becomes unselected pixel 73, while the unselected pixel in FIG. 7A becomes a selected pixel 74. In a video sequence of 30 image per second which is most commonly supported image rate, the duration between 2 images is 30 millisecond which is short and the rotation of selecting pixel in a 2:1 sampling ratio means all pixels will be sampled once every 60 millisecond.

FIG. 7C depicts the 4:1 sampling ratio. Under the 4:1 sampling ratio, the selected pixel of the four pixels is shown in black positions of 7C1, 7C2, 7C3 and 7C4. Since the sub-sampling ratio is 4:1, the present invention periodically rotates the selecting position 76, 77, 78, 79 from image to image in a group of four images to reduce the error caused by the subsampling. The subsampling means with optimized selection point is used throughout the complete invention of the bit stream encoding and the calculation of MAD and decision making of skip block and skip image. Theoretically, the computing speed in the motion estimation and block pixel difference, block variance get doubled by adopting the 2:1 subsampling ratio and becomes 4× faster by 4:1 subsampling ratio since the number of calculation is proportionally reduced by a factor of 2 in 2:1 subsampling ratio and 4 in the 4:1 subsampling ratio.

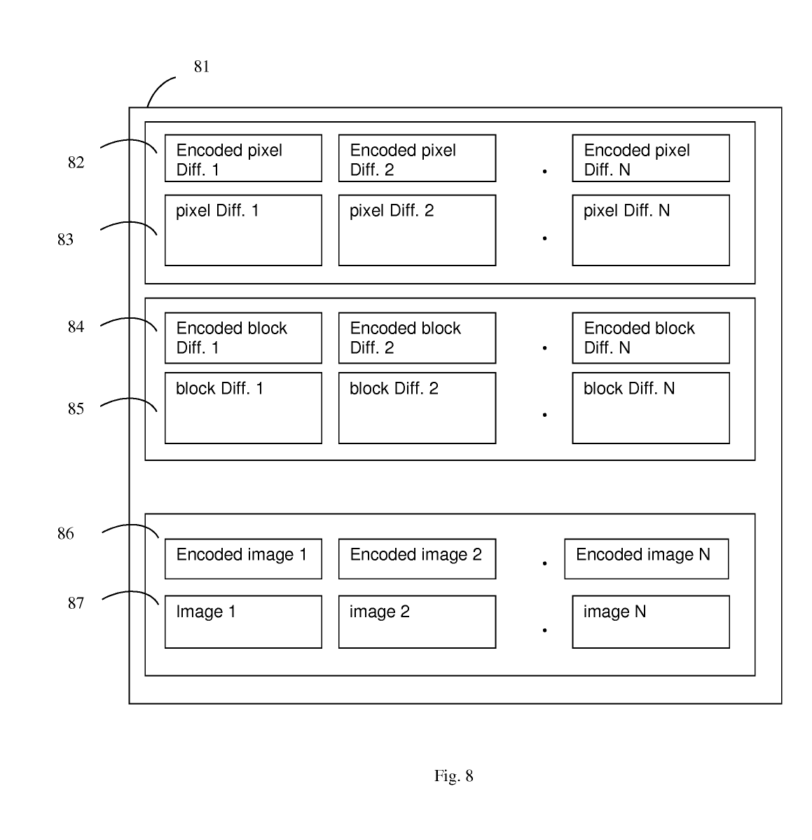

FIG. 8 illustrates the buffer 81 where stores six different things, the reference of pixel differences 83 and the encoded reference of pixel differences 82, the reference of block differences 85 and the encoded reference of block differences 84, and the reference of image 87 and the encoded reference of image 86 to let the method choose the best corresponding encoded results.

When the current data comes, the method starts to differentiate which type it is. The current data is image itself and after calculating the entire divergent level, the current image will compare with the predetermined threshold to decide which compression procedures are to be used. Then, the method searches the best match reference for the current data. The buffer 81 provides every possibility to the method to find the best match corresponding result to represent the current data.

What is claimed is:

1. A method for encoding a video stream, the video stream comprising a series of images, each image being divided into a plurality of blocks, comprising:
storing a set of encoded image data in a buffer, each encoded image data in the set of encoded image data in the buffer being an encoded result corresponding to an image previously encoded;
finding whether any image corresponding the set of encoded image data in the buffer having an image divergent level with respect to an image to be encoded being smaller than TH2;
choosing the smallest image divergent level as the best match image divergent level from a pool of reference images in the buffer after comparing each image divergent level; and
if such image being available, retrieving the encoded image data in the buffer associated to such image as the encoded result of the current image to be encoded.

2. The method of claim 1, wherein after comparing the current image, if the entire image divergent level is smaller than TH2, copying the encoded result of the best match reference image as the current image result.

3. The method of claim 1, wherein the image divergent level is not smaller than TH2, the current image is converted into frequency space and ignoring part of image elements to do the further compression.

4. The method of claim 1, further comprising:
storing a set of encoded block data in the buffer, each encoded block data in the set of encoded block data in the buffer being an encoded result corresponding to a block previously encoded;
finding whether any block corresponding the set of encoded block data in the buffer having a block divergent level with respect to a current block to be encoded being smaller than TH1;
if such block being available, retrieving the encoded block data in the encoded result of the current block to be encoded.

5. The method of claim 4, wherein the buffer stores each block divergent level between the current block and the reference blocks and each block divergent level encoded results.

6. The method of claim 5, wherein the method compares the entire block divergent level within the current block to find the best match reference block from the buffer.

7. The method of claim 6, wherein the current block compares the reference blocks uses alternation, random choosing, or comparing the neighboring blocks or subsampling to select delegates.

8. The method of claim 7, wherein subsampling means to divide the current block and calculate one or more blocks in groups.

9. The method of claim 4, wherein the method chooses the smallest block divergent level from a pool of reference blocks in the buffer after comparing each block divergent level.

10. The method of claim 4, wherein after comparing the entire block divergent level, if the entire block divergent level is smaller than TH1, copying the encoded results in the buffer.

11. The method of claim 4, wherein the block divergent level is not smaller than TH1, the current block is converted into frequency space and ignoring part of block elements to do the further compression.

12. The method of claim 4, further comprising:
storing a set of encoded pixel data in the buffer, each encoded pixel data in the set of encoded pixel data in the third buffer being an encoded result corresponding to a pixel previously encoded;
finding whether any pixel corresponding the set of encoded pixel data in the third buffer having a pixel divergent level with respect to a current pixel to be encoded ;
if such pixel being available, retrieving the encoded pixel data in the third buffer associated to such pixel as the encoded result of the current pixel to be encoded.

13. The method of claim 12, wherein the buffer stores each pixel divergent level between the current pixel and the reference pixels and each pixel divergent level encoded results.

14. The method of claim 13, wherein the method compares the entire pixel divergent level within the current pixel to find the best match reference pixel from the buffer.

15. The method of claim 14, wherein the current pixel compares the reference image block pixels uses alternation, random choosing, or comparing the neighboring blocks or subsampling to select delegates.

16. The method of claim 15, wherein subsampling means to divide the current pixel and calculate one or more pixels in groups.

17. The method of claim 12, wherein the method chooses the smallest pixel divergent level from a pool of reference pixels in the buffer after comparing each pixel divergent level.

18. The method of claim 12, wherein the pixel divergent level is not smaller than TH1, the current pixel ignore part of pixel elements to acquire the encoded result of the current pixel.
